(19) United States
(12) Patent Application Publication
(10) Pub. No.: US 2024/0104189 A1
(43) Pub. Date: Mar. 28, 2024

(54) COMPUTER BASED SYSTEMS CONFIGURED TO SURFACE EXPECTED DEMOGRAPHIC QUERIES WITHIN INTERACTION SESSIONS AND METHODS OF USE THEREOF

(71) Applicant: Capital One Services, LLC, McLean, VA (US)

(72) Inventors: Joshua Edwards, Philadelphia, PA (US); Lin Ni Lisa Cheng, Great Neck, NY (US); Asher Smith-Rose, Midlothian, VA (US); Tyler Maiman, Melville, NY (US); Shabnam Kousha, Washington, DC (US)

(21) Appl. No.: 17/946,967

(22) Filed: Sep. 16, 2022

(51) Int. Cl. G06F 21/50; G06F 16/23; G06F 16/28

(52) U.S. Cl. CPC G06F 21/50; G06F 16/23; G06F 16/284

(57) ABSTRACT

In some embodiments, the present disclosure provides an exemplary method that may include steps of obtaining a permission from the user to monitor a plurality of activities executed within the computing device; continually monitoring the plurality of activities executed within the computing device for a predetermined period of time; identifying an indication of an incoming interaction session within the predetermined period of time; automatically verifying a session interaction parameter associated with the incoming interaction session; determining a plurality of inquires associated with the research interaction session based on the at least one session interaction parameter; identifying the plurality of demographic informational items associated with the user; and automatically updating the programmable GUI element to display the plurality of inquires associated with the interaction session and the plurality of demographic informational items associated with the user.

### FIELD OF TECHNOLOGY

The present disclosure generally relates to computer-based systems configured to surface expected demographic queries within an interaction session and methods of use thereof.

### BACKGROUND OF TECHNOLOGY

Typically, a plurality of queries or questions comprise a call script associated for interaction sessions or phone calls. These queries are directed to the purpose of obtaining demographic informational items associated with the user. The user, in most instances, is required to retrieve answers to these questions while the interaction session is ongoing. This may decrease a level of efficiency in placing a plurality of these interaction sessions, and a level of efficiency for a user to retrieve one answer per query during the interaction session.

### SUMMARY OF DESCRIBED SUBJECT MATTER

In some embodiments, the present disclosure provides an exemplary technically improved computer-based method that includes at least the following steps of obtaining, by at least one processor of a first computing device associated with a user, via at least one graphical user interface (GUI) having at least one programmable GUI element, a permission from the user to monitor a plurality of activities executed within the computing device; continually monitoring, by the at least one processor of the first computing device, in response to obtaining the permission from the user, the plurality of activities executed within the computing device for a predetermined period of time; identifying, by the at least one processor of the first computing device, an indication of an incoming interaction session being initiated with the user within the predetermined period of time; automatically verifying, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters; determining, by the at least one processor of the first computing device, a plurality of inquires associated with the research interaction session based on the at least one session interaction parameter, where the plurality of inquires require a plurality of demographic informational items associated with the user; identifying, by the at least one processor of the first computing device, the plurality of demographic informational items associated with the user; and automatically updating, by the at least one processor of the first computing device, the at least one GUI having the at least one programmable GUI element to display: i) the plurality of inquires associated with the research interaction session and ii) the plurality of demographic informational items associated with the user.

In some embodiments, the present disclosure provides an exemplary technically improved computer-based system that includes at least the following components of at least one processor configured to execute software instructions that cause the at least one processor to perform steps to: obtain, by at least one processor of a first computing device associated with a user, via at least one graphical user interface (GUI) having at least one programmable GUI element, a permission from the user to monitor a plurality of activities executed within the computing device; continually monitor, by the at least one processor of the first computing device, in response to obtaining the permission from the user, the plurality of activities executed within the computing device for a predetermined period of time; identify, by the at least one processor of the first computing device, an indication of an incoming interaction session being initiated with the user within the predetermined period of time; automatically verify, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters; determine, by the at least one processor of the first computing device, a plurality of inquires associated with the research interaction session based on the at least one session interaction parameter, where the plurality of inquires require a plurality of demographic informational items associated with the user; identify, by the at least one processor of the first computing device, the plurality of demographic informational items associated with the user; and automatically update, by the at least one processor of the first computing device, the at least one GUI having the at least one programmable GUI element to display: i) the plurality of inquires associated with the research interaction session and ii) the plurality of demographic informational items associated with the user.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram show one or more schematic flow diagrams, certain computer-based architectures, and/or screenshots of various specialized graphical user interfaces which are illustrative of some exemplary aspects of at least some embodiments of the present disclosure.

FIG. 2 is a flowchart illustrating operational steps for automatically updating a computing device associated with a user to display a plurality of inquires associated with a research interaction session and a plurality of demographic informational items associated with the user, in accordance with one or more embodiments of the present disclosure.

FIG. 3A-3C are diagrams illustrating exemplary graphical user interfaces (GUIs) involving aspects and features associated with the interactive communication based on at least one interaction notification on a computing device associated with a user, in accordance to one or more embodiments of the present disclosure.

FIG. 4 depicts an exemplary diagram of an exemplary computer-based system and platform for automatically updating a computing device associated with a user to display a plurality of inquires associated with a research interaction session and a plurality of demographic informational items associated with the user, in accordance with at least one embodiment of the present disclosure.

FIG. 5 depicts a block diagram of an exemplary computer-based system/platform in accordance with one or more embodiments of the present disclosure.

FIG. 6 depicts a block diagram of another exemplary computer-based system/platform in accordance with one or more embodiments of the present disclosure.

FIGS. 7 and 8 are diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

At least some embodiments of the present disclosure provide technological solution(s) to a technological computer-centered problem associated with requiring a user to retrieve a plurality of answers to a plurality of queries associated with a pre-scripted set of queries associated with the interaction session. The technological computer-centered problem associated with the retrieval of the plurality of answers associated with the plurality of queries within the interaction session typically arises when a user is required to retrieve demographic information associated with at least one account of the user to answer at least one question in a plurality of questions during a interaction session, which increases the duration of the interaction session and decreases the efficiency of the user who is required to either know the answer from memory or retrieve the answer from a database of records. There is a need for a technological computer-centered solution that determines the plurality of questions associated with the interaction session, identifying the plurality of answers associated with the user, and automatically updating a computing device associated with the user to display the plurality of questions and the plurality of answers during the interaction session. In some embodiments, the present disclosure may utilize an information update module to determine a plurality of inquiries associated with a research interaction session, identify a plurality of demographic informational items associated with the user, and automatically update the computing device associated with the user to display the plurality of inquires associated with the research interaction session and the plurality of demographic informational items associated with the user. In some embodiments, the research intersession may refer to an incoming phone call, email, text message, or facetime call with at least one personal detail associated with the identity of the user. In some instances, the present disclosure may utilize the information update module to automatically update the computing device associated with the user to display the plurality of inquires and the plurality of demographic informational items to improve the optimization of the retrieval and display of a plurality of answers to a plurality of questions associated with a interaction session based on a crowd sourcing algorithm to survey a plurality of previous users to determine the plurality of questions associated with the interaction session. In some embodiments, the present disclosure provides a computer-centric technology solution that may include dynamically determining a comfort level associated with the user by receiving a plurality of preferences associated with the user to establish a confidence baseline for the plurality of inquires associated with the interaction session.

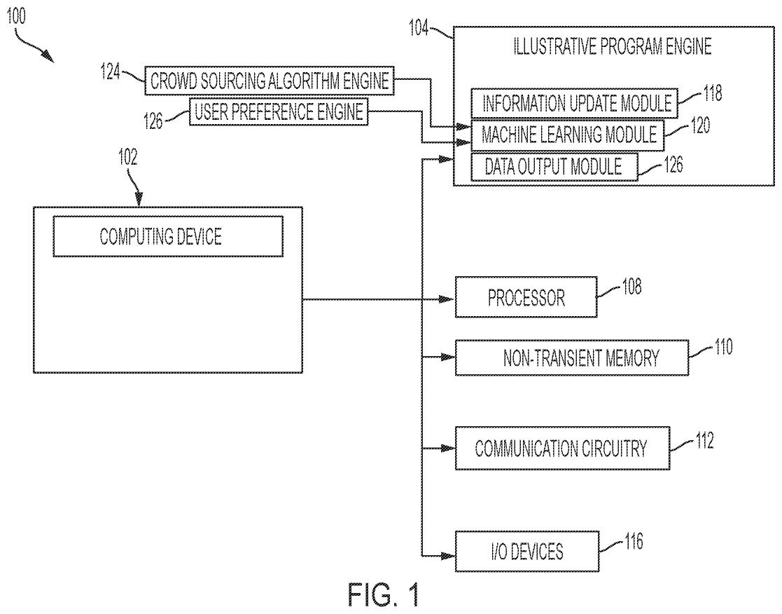

FIG. 1 depicts a block diagram of an exemplary computer-based system and platform for automatically updating a computing device associated with a user to display a plurality of inquires associated with a research interaction session and a plurality of demographic informational items associated with the user, in accordance with at least one embodiment.

In some embodiments, an illustrative computing system pf the present disclosure 100 may include a computing device 102 associated with a user and an illustrative program engine 104. In some embodiments, the program 104 may be stored on the computing device 102. In some embodiments, the illustrative program engine 104 may reside on a server computing device 106 (not shown). In some embodiments, the computing device 102 may include a processor 108, a non-transient memory 110, a communication circuitry 112 for communicating over a communication network 114 (not shown), and input and/or output (I/O) devices 116 such as a keyboard, mouse, a touchscreen, and/or a display, for example.

In some embodiments, the illustrative program engine 104 may be configured to instruct the processor 108 to execute one or more software modules such as, without limitations, an information update module 118, a machine learning module 120, and/or a data output module 122.

In some embodiments, an exemplary information update module 118, of the present disclosure, utilizes at least one machine learning algorithm, described herein, to determine a plurality of inquiries associated with a research interaction session, identify a plurality of demographic informational items associated with the user, and automatically update the computing device associated with the user to display the plurality of inquires associated with the research interaction session and the plurality of demographic informational items associated with the user. For example, the demographic informational items may refer to passwords, PIN numbers, birth dates, social security numbers, account numbers and any information associated with the user that may require the user to retrieve the information from a personal record database. Typically, the requirement of the user to retrieve each demographic informational item in response to at least one inquiry associated with an incoming interaction session may add an unknown duration to the research interaction session to account for the user retrieving each demographic informational item and/or may hinder the optimization associated with the research interaction session. In some instances, the incoming interaction session may refer to a research interaction session, which has a purpose to gain more demographic informational items associated with the user.

In some embodiments, the exemplary information update module 118 may obtain a permission from the user to monitor a plurality of activities executed within the computing device 102 via at least one graphical user interface (“GUI”) having at least one programmable GUI element. In some embodiments, the exemplary information update module 118 may continually monitor the plurality of activities executed within the computing device 102 for a predetermined period of time in response to obtaining the permission from the user. In some embodiments, exemplary information update module 118 may identify an indication of an incoming interaction session being initiated with the user within the determined period of time. In some embodiments, the incoming interaction session may refer to an incoming phone call, facetime call, conference call, and/or email. In some embodiments, the exemplary information update module 118 may automatically verify at least one session interaction parameter associated with the incoming interaction session to identify the incoming interaction session as a research interaction session. In some embodiments, the exemplary information update module 118 may identify the incoming interaction session as the research interaction session when the at least one session interaction parameter of the incoming interaction session is associated with at least one of a particular entity, a particular individual, or a particular physical location based on a databased on known session interaction parameters. In some embodiments, the session interaction parameter may refer to a session interaction protocol (SIP) certificate. In some embodiments, the exemplary information update module 118 may determine a plurality of inquires associated with the research interaction session based on the at least one session interaction parameter.

In some embodiments, the exemplary information update module 118 may determine that the plurality of inquires require a plurality of demographic informational items associated with the user. In some embodiments, the demographic informational items may refer to a plurality of answers associated to the plurality of inquires within the research interaction session. For example, the demographic informational items may refer to passwords, PIN numbers, birth dates, social security numbers, account numbers and any information associated with the user that may require the user to retrieve the information from a personal record database. In some embodiments, the exemplary information update module 118 may identify the plurality of demographic informational items associated with the user. In some embodiments, the exemplary information update module 118 may automatically retrieve the plurality of demographic information items associated with the user from an external data source in response to determining the plurality of inquiries associated with the research interaction session. In some embodiments, the external data source may refer to the server computing device 106. In some embodiments, the exemplary information update module 118 may automatically update the at least one GUI having the at least one programmable GUI element to display the plurality of inquiries associated with the research interaction session and the plurality of demographic informational items associated with the user. In some embodiments, the exemplary information update module 118 may automatically halt the continuous monitoring of the plurality of activities based on the plurality of inquires associated with the research interaction session meeting or exceeding a predetermined threshold of inquiries. In some embodiments, the predetermined threshold of inquires may refer to a preference associated with the user that contributes to the comfort threshold associated with the user based on the plurality of preferences associated with the user. For example, the user may determine that six questions are the limit of inquires the user is willing to answer, thus the predetermined threshold of inquires is six; and any inquiries asked during the research interaction session after question six may not be monitored.

In some embodiments, the exemplary information update module 118 may determine the plurality of inquires associated with the research interaction session by utilizing a crowd sourcing algorithm engine 124 to survey a plurality of previous users on a respective research interaction session within a plurality of previous research interaction sessions. In some embodiments, the crowd sourcing algorithm engine 124 monitors the plurality of previous research interaction sessions and the plurality of previous users; surveys the plurality of previous users to determine queries presented within the plurality of previous research interaction session, where the surveyed queries may refer to input of the crowd sourcing algorithm engine 124; rank the determined queries based on a frequency of responses from the plurality of previous users; and automatically select at least five queries of the determined queries based on the frequency of responses from the plurality of previous users, where the selected queries may refer to output of the crowd sourcing algorithm engine 124. In some embodiments, the exemplary information update module 118 may automatically update the computing device 102 associated with the user by retrieving at least one answer to each inquiry of the plurality of inquires within the plurality of demographic informational items and displaying the at least one answer to each of the plurality of inquiries on the at least one GUI having the at least one programmable GUI element within the computing device 102. In some embodiments, the exemplary information update module 118 may utilize a user preference engine 126 to calculate a comfort level associated with the user based on receiving the plurality of preferences associated with the user, where the comfort level is at least one point within a range. In some embodiments, the range associated with the comfort level may be on a scale of one to five, where one represents a lowest value on the range and five represents a highest value on the range. In some embodiments, each respective value on the range is associated with a comparison of the received plurality of preferences associated with the user to the responses of the plurality of previous users. In some embodiments, a comfort level threshold may be a predetermined value within the range. In some embodiments, the comfort level may refer to a confidence threshold associated with the user based on the received preferences associated with the user. For example, the comfort level may limit the number of inquires that the user is comfortable answering, the duration of the interaction session, and the demographic informational items the user is willing to share. In some embodiments, the exemplary information update module 118 may store a plurality of demographic informational items associated with at least second-type user in a pre-generated database of known entities. In some embodiments, the exemplary information update module 118 may automatically modify at least one second-type user-related record from the pre-generated database based on an at least one action by the at least one second-type user during at least one user-specific interaction session prior to the research interaction session. In some embodiments, the exemplary information update module 118 may automatically reject the incoming interaction session based on the plurality of inquires associated with the research interaction session meeting or exceeding the predetermined threshold of comfort associated with the user.

In some embodiments, the present disclosure describes systems for utilizing the machine learning module 120 for determining the plurality of inquires associated with the research interaction session based on the at least one session interaction parameter. In some embodiments, the plurality of inquires associated with the research interaction session may require the plurality informational items associated with the user. In some embodiments, the machine learning module 120 may identify the plurality of demographic informational items associated with the user required by the plurality of inquires associated with the research interaction session. In some embodiments, the machine learning module 120 may automatically update the at least one GUI having the at least one programmable GUI element within the computing device 102 to display the plurality of inquires associated with the research interaction session and the plurality of demographic informational items associated with the user. In some embodiments, the machine learning module 120 may utilize the crowd sourcing algorithm engine 124 to determine the plurality of inquires associated with the incoming interaction session by surveying a plurality of previous users on respective interaction sessions within a plurality of previous interaction sessions. In some embodiments, the machine learning module 120 may utilize a user preference engine 126 to calculate a comfort level associated with the user by receiving the plurality of preferences associated with the user. In some embodiments, the machine learning module 120 may utilize the user preference engine 126 to determine the calculated comfort level associated with the user. In some embodiments, output of the machine learning module 120 may the display of the plurality of inquires associated with the research interaction session and the display of the plurality of demographic informational items associated with the user on the computing device 102 via the GUI programmable element. In some embodiments, the output of the machine learning module 120 may refer to the survey of the plurality of previous users on the respective interaction sessions within the plurality of previous interaction sessions. In some embodiments, the output of the machine learning module 120 may refer to the calculated comfort level associated with the user based on the received plurality of preferences associated with the user.

In some embodiments, the data output module 122 may determine the plurality of inquires associated with the research interaction session based on the at least one session interaction parameter. In some embodiments, the data output module 122 may determine the plurality of inquires associated with the research interaction session require the plurality of demographic informational items associated with the user. In some embodiments, the data output module 122 may identify the plurality of demographic informational items associated with the user required by the plurality of inquires associated with the research interaction session. In some embodiments, the data output module 122 may automatically update the at least one GUI having the at least one programmable GUI element within the computing device 102 to display the plurality of inquires associated with the research interaction session and the plurality of demographic informational items associated with the user. In some embodiments, the data output module 122 may display the plurality of inquires associated with the research interaction session via the GUI programmable element within the computing device 102. In some embodiments, the data output module 122 may display the plurality of demographic informational items associated with the user via the GUI programmable element within the computing device 102.

In some embodiments, the illustrative program engine 104 may obtain a permission from the user to monitor a plurality of activities executed within the computing device 102 via the least one graphical user interface (GUI) having at least one programmable GUI element. In some embodiments, the illustrative program engine 104 may continually monitor the plurality of activities executed within the computing device 102 for a predetermined period of time in response to obtaining the permission from the user. In some embodiments, the illustrative program engine 104 may identify an indication of an incoming interaction session being initiated with the user within the predetermined period of time. In some embodiments, the illustrative program engine 104 may automatically verify at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters. In some embodiments, the illustrative program engine 104 may determine the plurality of inquires associated with the research interaction session based on the at least one session interaction parameter. In some embodiments, the illustrative program engine 104 may identify the plurality of demographic informational items associated with the user. In some embodiments, the illustrative program engine 104 may automatically update the at least one GUI having the at least one programmable GUI element within the computing device 102 to display the plurality of inquires associated with the research interaction session and the plurality of demographic informational items associated with the user.

In some embodiments, the non-transient memory 110 may store the automatic updates that may be displayed on the computing device 102 via the at least one GUI having the at least one programmable GUI element. In some embodiments, the non-transient memory 110 may store the plurality of inquires associated with the research interaction session and the plurality of demographic informational items associated with the user as the output of the machine learning module 120 utilizing the exemplary information update module 118.

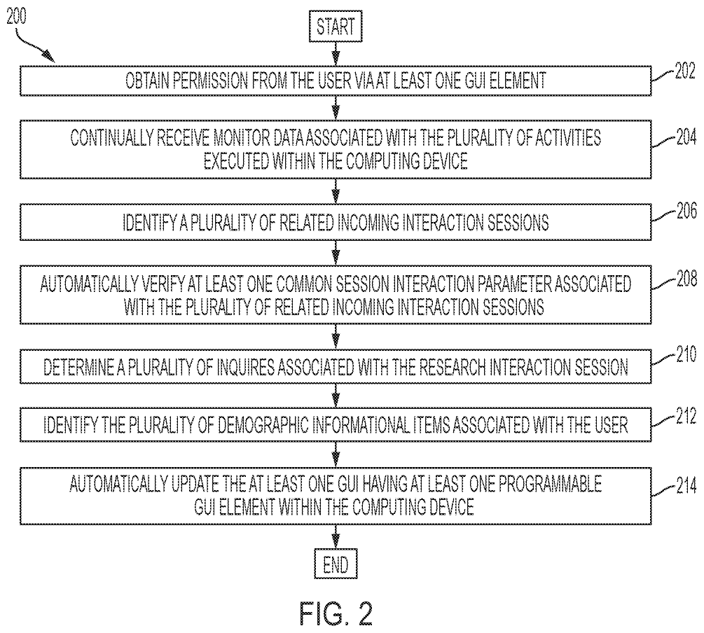

FIG. 2 is a flowchart 200 illustrating operational steps for automatically updating a computing device associated with a user to display a plurality of inquires associated with a research interaction session and a plurality of demographic informational items associated with the user, in accordance with one or more embodiments of the present disclosure.

In step 202, the illustrative program engine 104 within the computing device 102 may be programmed to obtain a permission from the user to monitor a plurality of activities executed within the computing device 102. Inn some embodiments, the illustrative program engine 104 may obtain the permission from the user to monitor the plurality of activities executed within the computing device 102 via at least one graphical user interface (GUI) having at least one programmable GUI element.

In step 204, the illustrative program engine 104 may continually monitor the plurality of activities executed within the computing device 102 for a predetermined period of time. In some embodiments, the illustrative program engine 104 may continually monitor the plurality of activities executed within the computing device 102 for the predetermined period of time in response to obtaining the permission from the user. In some embodiments, the illustrative program engine 104 may automatically halt the continual monitoring of the plurality of activities based on a plurality of inquires associated with a research interaction session meeting or exceeding a predetermined threshold of activities. In some embodiments, the predetermined threshold of activities may refer to a preference received from the user.

In step 206, the illustrative program engine 104 may identify an indication of an incoming interaction session being initiated with the user within the predetermined period of time. In some embodiments, the incoming interaction session may refer to an incoming phone call.

In step 208, the illustrative program engine 104 may automatically verify at least one session interaction parameter associated with the incoming interaction session. In some embodiments, the illustrative program engine 104 may automatically verify the at least one session interaction parameter associated with the incoming interaction session to identify the incoming interaction session as the research interaction session when the at least one session interaction parameter is associated with at least one of a particular entity, a particular individual, or a particular physical location based on a database of known session interaction parameters. In some embodiments, the at least one session interaction parameter may refer to a session initiation protocol certificate associated with the research interaction session.

In step 210, the illustrative program engine 104 may determine a plurality of inquires associated with the research interaction session. In some embodiments, the illustrative program engine 104 may utilize a crowd sourcing algorithm engine 124 to determine the plurality of inquires associated with the incoming interaction session by surveying a plurality of previous users on respective interaction sessions within a plurality of previous interaction sessions. In some embodiments, the plurality of inquires may require a plurality of demographic informational items associated with the user. In some embodiments, the illustrative program engine 104 may utilize a user preference engine to calculate a comfort level by receiving user preferences. In some embodiments, the illustrative program engine 104 may determine a calculated comfort level associated with the user based on receiving a plurality of preferences associated with the user.

In step 212, the illustrative program engine 104 may identify the plurality of demographic informational items associated with the user. In some embodiments, the plurality of demographic informational items may refer to a plurality of answers associated with the plurality of inquiries. In some embodiments, the demographic informational items may refer to passwords, PIN numbers, date of birth, social security numbers, and any other personal information associated with the user. In some embodiments, the illustrative program engine 104 may store a plurality of demographic informational items associated with at least one second-type user in a pre-generated database of known entities and automatically modify at least one second-type user-related record from the pre-generated database based on an at least one action by the at least one second-type user during at least one user-specific interaction session prior to the research interaction session.

In step 214, the illustrative program engine 104 may automatically update the at least one GUI having the at least one programmable GUI element within the computing device 102. In some embodiments, the illustrative program engine 104 may automatically update the at least one GUI having the at least one programmable GUI element within the computing device 102 to display the plurality of inquires associated with the research interaction session and the plurality of demographic informational items associated with the user. In some embodiments, the illustrative program engine 104 may automatically update the at least one GUI having the at least one programmable GUI element within the computing device 102 by retrieving at least one answer to each inquiry of the plurality of inquiries within the plurality of demographic informational items and displaying the at least one answer to each inquiry of the plurality of inquiries on the at least one GUI having the at least one programmable GUI element. In some embodiments, the illustrative program engine 104 may automatically reject the incoming interaction session based on the plurality of inquires associated with the research interaction session meeting or exceeding a predetermined threshold of comfort associated with the user.

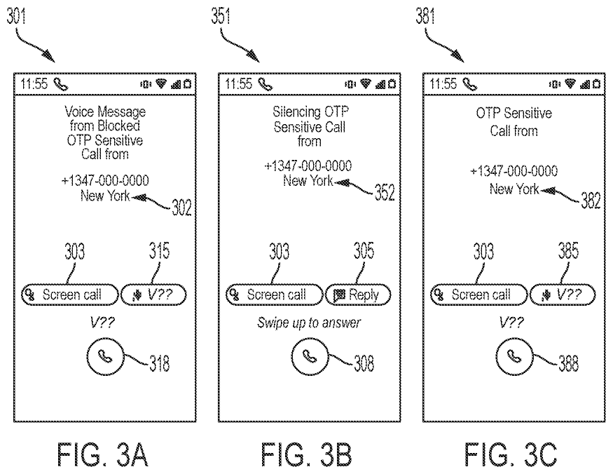

FIGS. 3A-3C are diagrams illustrating exemplary graphical user interfaces (GUIs) involving aspects associated with the exemplary information update module 118 consistent with exemplary aspects of certain embodiments of the present disclosure. In some embodiments, the GUIs may be provided by an application and shown on a display of a mobile device (e.g., the computing device 102 of FIG. 1). In some embodiments, prior to the GUIs being displayed in response to an incoming call at the mobile device, a session interaction parameter (e.g., SIP certificate) has been received at the mobile device to activate, for example, the application into applying a plurality of measures for the incoming call being associated with a research interaction session associated with another computing device that maintains a historical data relationship, and the like. In some embodiments, when the session interaction parameter becomes invalid after its pre-configured lifetime expires, the application may be deactivated at least to the extent that the triggered security measures would be no longer active due to the fact that there would be no valid session interaction parameters for any fraudulent entities to attack. The embodiment illustrated in FIGS. 3A-3C may correspond to another protection flow path, where the user would receive an incoming phone call from one of the phone numbers determined by, for example, the machine learning module 120, as a research interaction, and would not have answered it yet.

FIG. 3A illustrates an exemplary GUI 301 of the application for notifying the user of an incoming call that is associated with a repeat interaction session and automatically updating the call screen with a plurality of inquiries and a plurality of demographic informational items associated with the user. The GUI 301 may include an alert 302, and a set of buttons 303 for the user to select, as well as options 315 and 318, that display at least inquiry and at least one demographic informational item. Here, the alert 302 may notify the user that the voice message has been identified as from a research interaction (e.g., the call identified as coming from an entity determined for the purpose of retrieving additional information from the user). The alert 302 may include the phone number of the calling entity, i.e., “1-347-000-0000,” and “New York” as the area associated with the phone number's area code.

As illustrated at GUI 301, the application would be actively verifying the incoming call and retrieving and displaying appreciate pieces of data associated with the user to optimize the interaction session based on the valid session interaction parameter. In some embodiments, the user can interact with the selectable options 315 or 318 to perform certain actions when the research call is a pending incoming call. As shown here, the user can select the option 315 to reply with a message associated with the plurality of inquires or select the option 318 to swipe up to retrieve at least one demographic information item to answer at least one inquiry associated with the research call. In some embodiments, the user can select the button 303 to screen the research call. In some embodiments, the user can select the button 303 to screen a voice message from the research call. In other embodiments, the button 303 may be disabled as well so that the user cannot screen the research call either. The incoming call can be screened by various techniques to evaluate the characteristics of the calling entity. Exemplary screening techniques may include the user screening a message being recorded on an answering machine or voice mail, the user checking a caller ID display to see who or where the call is from, and the user checking the time or date which a call or message was received. Exemplary screening techniques may also include connecting the calling party to a chatbot service such that the chatbot service may screen the calling party and/or record the conversion. In implementations, screening may be performed by protocols such as Secure Telephony Identity Revisited (STIR), Signature-based Handling of Asserted information using tokens (SHAKEN) to identify calls associated with spoofed phone numbers, and the like.

Further, the user may perform other actions upon the incoming call in addition to or in place of those illustrated in FIG. 3A. For example, the user can interact with the GUI 301 to decline the incoming call while it is still being verified, report the phone number included in the alert 302 to a server (e.g., the server computing device 106 of FIG. 1) or log locally as associated with a research entity without screening the call or after screening the call, report the phone number or log locally as associated with a fraudulent entity after selecting the button 308 to answer the call, report the phone number or log locally as not associated with a fraudulent entity after selecting the button 308 to answer the call, and the like. In one embodiment, the application that verifies the incoming call during the lifetime of the valid session interaction parameter may display, through the GUI, at least one demographic informational item to the user when an incoming research call being answered by the user. That is, the application may be configured to display a plurality of inquires and a plurality of demographic informational items associated with the identified incoming calls as a background executing process without a visible GUI. In some embodiments, when the user interacts with the button 308 to answer the incoming call alerted as a research interaction.

FIG. 3B illustrates an exemplary GUI 351 of the application for notifying the user of an incoming call currently being identified. The GUI 351 may include an alert 352 and a set of buttons 303, 305, and 308 for the user to select. Here, the alert 352 may be similar to the alert 302 of FIG. 3A, notifying the user that the incoming call has been identified as a research interaction. The alert 302 may include the phone number of the calling entity, i.e., “1-347-000-0000,” and “New York” as the area associated with the phone number's area code. The difference here is that, at GUI 351, instead of identifying, the application is actively monitoring the incoming call. In some embodiments, the application may monitor the incoming call regardless of the setting already configured with regard to the phone functionality on the device to display the plurality of inquires and the plurality of demographic informational items associated with the plurality of inquires within the incoming interaction session.

Here, at GUI 351, when the application of the application is actively monitoring the incoming call in protection against a detected/potential vishing attack against the valid session interaction parameter, the user nevertheless can also interact with the selectable options to perform actions with regard to the pending incoming call. In this example, the user can also select the button 303 to screen the research call, select the button 305 to reply with a message based on the plurality of demographic informational items, or select the button 308 to swipe up to answer the incoming call. The incoming call can be screened by various techniques to evaluate the characteristics of the calling entity as described above.

Further, the user may also perform other actions upon the incoming call in addition to or in place of those illustrated in FIG. 3B. For example, the user can interact with the GUI 351 to decline the incoming call while it is being identified, report the phone number included in the alert 352 to the server (e.g., the server computing device 106 of FIG. 1) or log it locally as associated with a research entity without screening the call or after screening the call, report or log locally the phone number as associated with a research entity after selecting the button 308 to answer the call, report or log locally the phone number as not associated with a research entity after selecting the button 308 to answer the call, and the like. In some embodiments, when the user interacts with the button 308 to answer the incoming call alerted as a research interaction.

FIG. 3C illustrates an exemplary GUI 381 for notifying the user of an incoming call via a negative user interface. The GUI 381 may include an alert 382 and a set of buttons 303, 385, and 388 for the user to select. Here, the alert 382 may be similar to the alert 302 of FIG. 3A and the alert 352 of FIG. 3B, notifying the user that the incoming call has been identified as a research interaction. The alert 382 may include the phone number of the calling entity, i.e., “1-347-000-0000,” and “New York” as the area associated with the phone number's area code. The difference here is that, at GUI 381, instead of identifying or monitoring, the application may be programmed to actively provide negative UIs in association with the incoming call. As illustrated in this embodiment, the button 355 may be rendered as un-selectable, as indicated by the exemplary dashed messaging icon and dashed label “Reply.” Similarly, the button 388 may be rendered un-selectable, as indicated by the exemplary dashed label “Swipe Up to Answer.”

Here, at GUI 381 of the application, unlike the GUIs 301 and 351, when the application is actively providing the negative UIs for the incoming call in protection against the detected/potential vishing attack against the valid session interaction parameter, the user can only interact with the regularly rendered UI elements (e.g., the button 303 is still available for the user to screen the incoming call), but no longer able to select the UI elements rendered negative, e.g., select the button 305 to reply with a message, or select the button 308 to swipe up to answer the incoming call.

Further, the user may be allowed to also perform other actions upon the incoming call in addition to or in place of those illustrated in FIG. 3C, if the corresponding UI elements are provided at the GUI 381. For example, the user may be allowed to interact with the GUI 381 to decline the incoming call, report the phone number included in the alert 382 to the server (e.g., the server computing device 106 of FIG. 1) or log locally as associated with a research entity without screening the call or after screening the call, and the like. In this example, without an operable button 388, the user may be prevented from answering the incoming call as he or she may still be able to at the GUIs 301 or 351.

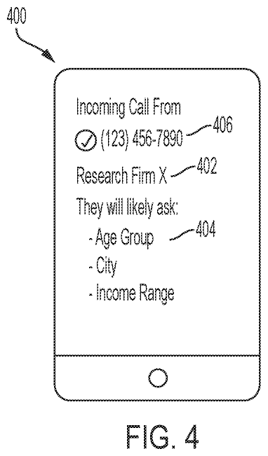

FIG. 4 depicts an exemplary diagram 400 of an exemplary computer-based system and platform for automatically updating a computing device associated with a user to display a plurality of inquires associated with a research interaction session and a plurality of demographic informational items associated with the user, in accordance with at least one embodiment of the present disclosure.

In some embodiments, the exemplary information update module 118 may identify an incoming interaction session as a research interaction session 402. In some embodiments, the exemplary information update module 118 may identify the incoming interaction session as the research interaction session 402 when the at least one session interaction parameter is associated with at least one of a particular entity, a particular individual, or a particular physical location based on a database of known session interaction parameters. In some embodiments, the exemplary information update module 118 may determine a plurality of inquires 404 associated with the research interaction session 402 that may be displayed via at least one GUI programmable element on the computing device 102. In some embodiments, the at least one session interaction parameter 406 may refer to a session initiation protocol certificate associated with the research interaction session 402 and may be displayed via at least one GUI programmable element on the computing device 102.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile;™ (20) Microsoft DirectX™; (21) NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary ASR system of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent tests for software agents that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, the exemplary ASR system of the present disclosure, utilizing at least one machine-learning model described herein, gaming, mobile-device games, video chats, video conferences, live video streaming, video streaming and/or augmented reality applications, mobile-device messenger applications, and others similarly suitable computer-device applications.

As used herein, the terms “mobile electronic device,” “mobile computing device,” “mobile device” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

The aforementioned examples are, of course, illustrative and not restrictive.

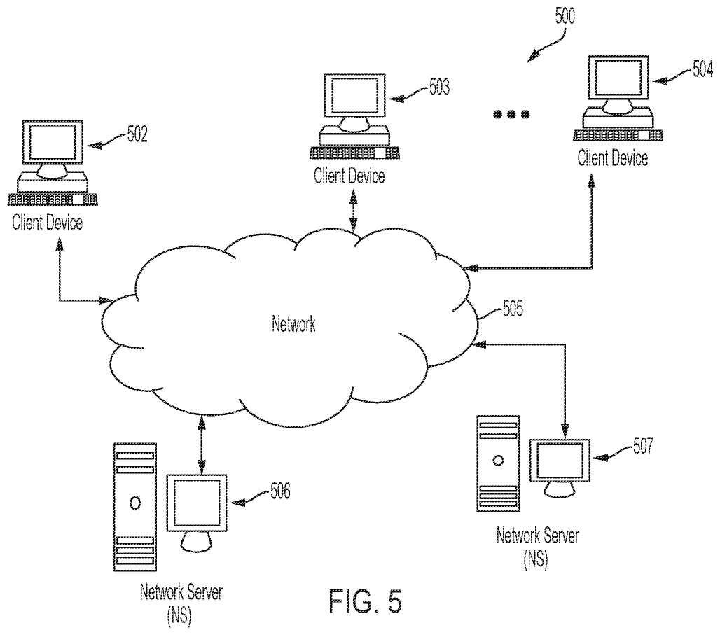

FIG. 5 depicts a block diagram of an exemplary computer-based system/platform 300 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 500 may be configured to manage launching a plurality of software applications within a computing device 102, as detailed herein. In some embodiments, the exemplary computer-based system/platform 500 may be based on a scalable computer and/or network architecture that incorporates varies strategies for assessing the data, caching, searching, and/or database connection pooling. An example of the scalable architecture is an architecture that is capable of operating multiple servers. In some embodiments, the exemplary inventive computing devices and/or the exemplary inventive computing components of the exemplary computer-based system/platform 500 may be configured to manage the exemplary information update module 118 of the present disclosure, utilizing at least one machine-learning model described herein.

In some embodiments, referring to FIG. 5, members 502-504 (e.g., clients) of the exemplary computer-based system/platform 500 may include virtually any computing device capable of simultaneously launching a plurality of software applications via a network (e.g., cloud network), such as network 505, to and from another computing device, such as servers 506 and 507, each other, and the like. In some embodiments, the member devices 502-504 may be personal computers, multiprocessor systems, microprocessor-based or programmable consumer electronics, network PCs, and the like. In some embodiments, one or more member devices within member devices 502-504 may include computing devices that connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 502-504 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 502-504 may include may launch one or more applications, such as Internet browsers, mobile applications, voice calls, video games, videoconferencing, and email, among others. In some embodiments, one or more member devices within member devices 502-504 may be configured to receive and to send web pages, and the like. In some embodiments, an exemplary information update module 118 of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 302-304 may be specifically programmed by either Java, Net, QT, C, C++ and/or other suitable programming language. In some embodiments, one or more member devices within member devices 502-504 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 505 may provide network access, data transport and/or other services to any computing device coupled to it. In some embodiments, the exemplary network 505 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 505 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 505 may include and implement, as an alternative or in conjunction with one or more of the above, a WiMAX architecture defined by the WiMAX forum. In some embodiments and, optionally, in combination of any embodiment described above or below, the exemplary network 505 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 505 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 505 may also include mass storage, such as network attached storage (NAS), a storage area network (SAN), a content delivery network (CDN) or other forms of computer or machine-readable media.

In some embodiments, the exemplary server 506 or the exemplary server 507 may be a web server (or a series of servers) running a network operating system, examples of which may include but are not limited to Microsoft Windows Server, Novell NetWare, or Linux. In some embodiments, the exemplary server 506 or the exemplary server 507 may be used for and/or provide cloud and/or network computing. Although not shown in FIG. 5, in some embodiments, the exemplary server 506 or the exemplary server 507 may have connections to external systems like email, SMS messaging, text messaging, ad content providers, etc. Any of the features of the exemplary server 506 may be also implemented in the exemplary server 507 and vice versa.

In some embodiments, one or more of the exemplary servers 506 and 507 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 501-504.

In some embodiments and, optionally, in combination of any embodiment described above or below, for example, one or more exemplary computing member devices 502-504, the exemplary server 506, and/or the exemplary server 507 may include a specifically programmed software module that may be configured to launch software applications and dynamically perform a plurality of predetermined stress tests.

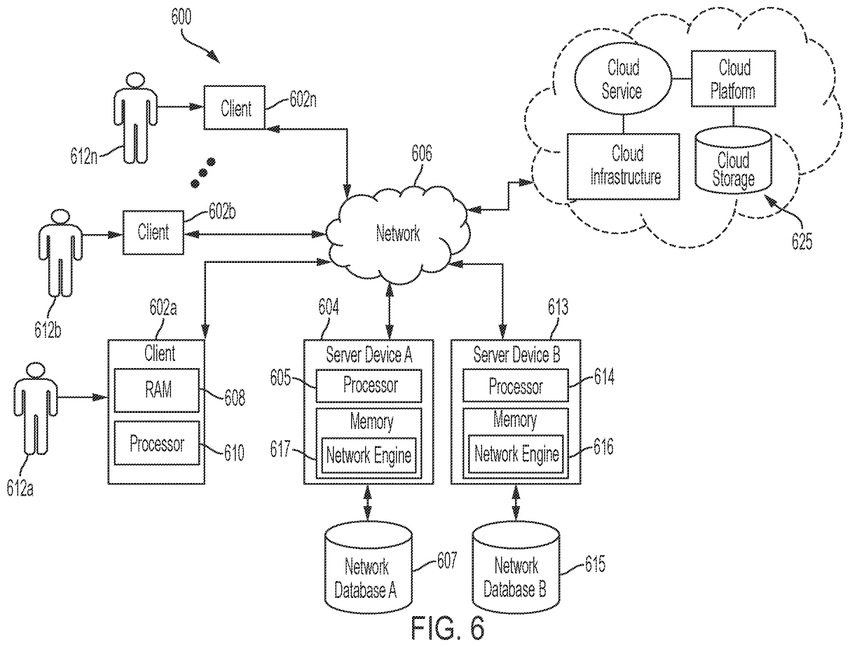

FIG. 6 depicts a block diagram of another exemplary computer-based system/platform 600 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 602b thru 602n shown each at least includes a computer-readable medium, such as a random-access memory (RAM) 608 coupled to a processor 610 or FLASH memory. In some embodiments, the processor 610 may execute computer-executable program instructions stored in memory 608. In some embodiments, the processor 610 may include a microprocessor, an ASIC, and/or a state machine. In some embodiments, the processor 410 may include, or may be in communication with, media, for example computer-readable media, which stores instructions that, when executed by the processor 610, may cause the processor 610 to perform one or more steps described herein. In some embodiments, examples of computer-readable media may include, but are not limited to, an electronic, optical, magnetic, or other storage or transmission device capable of providing a processor, such as the processor 610 of client 602a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 602a through 602n may also comprise a number of external or internal devices such as a mouse, a CD-ROM, DVD, a physical or virtual keyboard, a display, a speaker, or other input or output devices. In some embodiments, examples of member computing devices 602a through 602n (e.g., clients) may be any type of processor-based platforms that are connected to a network 606 such as, without limitation, personal computers, digital assistants, personal digital assistants, smart phones, pagers, digital tablets, laptop computers, Internet appliances, and other processor-based devices. In some embodiments, member computing devices 602a through 602n may be specifically programmed with one or more application programs in accordance with one or more principles/methodologies detailed herein. In some embodiments, member computing devices 602a through 602n may operate on any operating system capable of supporting a browser or browser-enabled application, such as Microsoft™ Windows™, and/or Linux. In some embodiments, member computing devices 602a through 602n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 602a through 602n, users, 612a through 612n, may communicate over the exemplary network 606 with each other and/or with other systems and/or devices coupled to the network 606. As shown in FIG. 6, exemplary server devices 604 and 613 may be also coupled to the network 606. Exemplary server device 604 may include a processor 605 coupled to a memory that stores a network engine 617. Exemplary server device 413 may include a processor 614 coupled to a memory 616 that stores a network engine. In some embodiments, one or more member computing devices 602a through 602n may be mobile clients. As shown in FIG. 6, the network 606 may be coupled to a cloud computing/architecture(s) 625. The cloud computing/architecture(s) 625 may include a cloud service coupled to a cloud infrastructure and a cloud platform, where the cloud platform may be coupled to a cloud storage.

In some embodiments, at least one database of exemplary databases 607 and 615 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

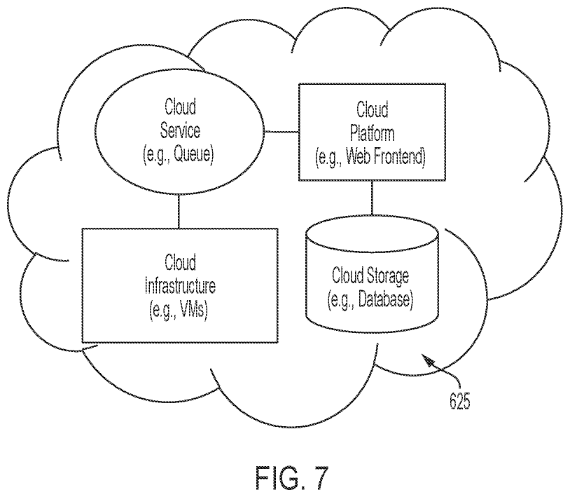

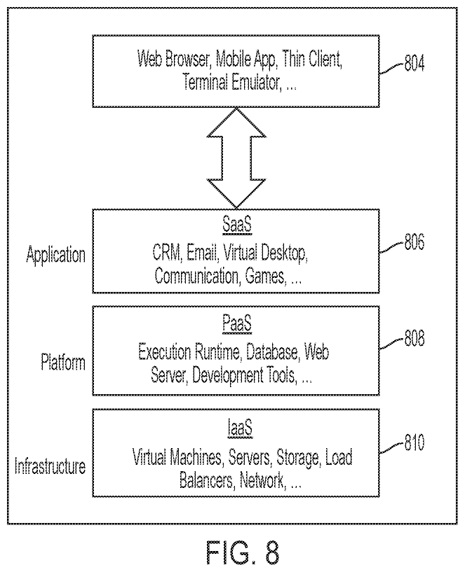

FIG. 7 and FIG. 8 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 7 illustrates an expanded view of the cloud computing/architecture(s) 625 found in FIG. 6. FIG. 8. illustrates the exemplary inventive computer-based components of the present disclosure may be specifically configured to operate in the cloud computing/architecture 625 as a source database 804, where the source database 804 may be a web browser. a mobile application, a thin client, and a terminal emulator. In FIG. 8, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 810, platform as a service (PaaS) 808, and/or software as a service (SaaS) 806.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

At least some aspects of the present disclosure will now be described with reference to the following numbered clauses.

Clause 1. A method may include: obtaining, by at least one processor of a first computing device associated with a user, via at least one graphical user interface (GUI) having at least one programmable GUI element, a permission from the user to monitor a plurality of activities executed within the computing device; continually monitoring, by the at least one processor of the first computing device, in response to obtaining the permission from the user, the plurality of activities executed within the computing device for a predetermined period of time; identifying, by the at least one processor of the first computing device, an indication of an incoming interaction session being initiated with the user within the predetermined period of time; automatically verifying, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters; determining, by the at least one processor of the first computing device, a plurality of inquires associated with the research interaction session based on the at least one session interaction parameter, where the plurality of inquires require a plurality of demographic informational items associated with the user; identifying, by the at least one processor of the first computing device, the plurality of demographic informational items associated with the user; and automatically updating, by the at least one processor of the first computing device, the at least one GUI having the at least one programmable GUI element to display: i) the plurality of inquires associated with the research interaction session and ii) the plurality of demographic informational items associated with the user.

Clause 2. The method according to clause 1, further including automatically halting a continual monitoring the plurality of activities based on the plurality of inquires associated with the research interaction session meeting or exceeding a predetermined threshold of inquiries.

Clause 3. The method according to clause 1 or 2, where determining the plurality of inquires associated with the incoming interaction session includes utilizing a crowd sourcing algorithm to survey a plurality of previous users on respective interaction sessions within a plurality of previous interaction sessions.

Clause 4. The method according to clause 1, 2 or 3, where the first computing device is a mobile device; and the incoming interaction session is an incoming phone call.

Clause 5. The method according to clause 1, 2, 3 or 4, where the at least one session interaction parameter is a session interaction protocol certificate associated with the research interaction session.

Clause 6. The method according to clause 1, 2, 3, 4 or 5, where automatically updating the at least one GUI having the at least one programmable GUI element includes: retrieving at least one answer to each inquiry of the plurality of inquiries within the plurality of demographic informational items, and displaying the at least one answer to each inquiry of the plurality of inquiries on the at least one GUI having the at least one programmable GUI element.

Clause 7. The method according to clause 1, 2, 3, 4, 5 or 6, further including determining a calculated comfort level associated with the user based on receiving a plurality of preferences associated with the user.

Clause 8. The method according to clause 1, 2, 3, 4, 5, 6 or 7, further including: storing a plurality of demographic information items associated with at least one second-type user in a pre-generated database of known entities; and automatically modifying at least one second-type user-related record from the pre-generated database based on an at least one action by the at least one second-type user during at least one user-specific interaction session prior to the research interaction session.

Clause 9. The method according to clause 1, 2, 3, 4, 5, 6, 7 or 8, further including automatically rejecting the incoming interaction session based on the plurality of inquires associated with the research interaction session meeting or exceeding a predetermined threshold of comfort associated with the user.

Clause 10. A method may include: obtaining, by at least one processor of a first computing device associated with a user, via at least one graphical user interface (GUI) having at least one programmable GUI element, a permission from the user to monitor a plurality of activities executed within the computing device; continually monitoring, by the at least one processor of the first computing device, in response to obtaining the permission from the user, the plurality of activities executed within the computing device for a predetermined period of time; identifying, by the at least one processor of the first computing device, an indication of an incoming interaction session being initiated with the user within the predetermined period of time; automatically verifying, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters; storing a plurality of demographic information items associated with at least one second-type user in a pre-generated database of known entities determining, by the at least one processor of the first computing device, a plurality of inquires associated with the research interaction session based on the at least one session interaction parameter, wherein the plurality of inquires require a plurality of demographic informational items associated with the user; identifying, by the at least one processor of the first computing device, the plurality of demographic informational items associated with the user; automatically updating, by the at least one processor of the first computing device, the at least one GUI having the at least one programmable GUI element to display: i) the plurality of inquires associated with the research interaction session and ii) the plurality of demographic informational items associated with the user; and automatically rejecting the incoming interaction session based on the plurality of inquires associated with the research interaction session meeting or exceeding a predetermined threshold of comfort associated with the user.

Clause 11. The method according to clause 10, further including automatically halting a continual monitoring the plurality of activities based on the plurality of inquires associated with the research interaction session meeting or exceeding a predetermined threshold of inquiries.

Clause 12. The method according to clause 10 or 11, where determining the plurality of inquires associated with the incoming interaction session includes utilizing a crowd sourcing algorithm to survey a plurality of previous users on respective interaction sessions within a plurality of previous interaction sessions.

Clause 13. The method according to clause 10, 11 or 12, where the first computing device is a mobile device; and the incoming interaction session is an incoming phone call.

Clause 14. The method according to clause 10, 11, 12 or 13, where the at least one session interaction parameter is a session interaction protocol certificate associated with the research interaction session.

Clause 15. The method according to clause 10, 11, 12, 13 or 14, where automatically updating the at least one GUI having the at least one programmable GUI element comprises: retrieving at least one answer to each inquiry of the plurality of inquiries within the plurality of demographic informational items, and displaying the at least one answer to each inquiry of the plurality of inquiries on the at least one GUI having the at least one programmable GUI element.

Clause 16. The method according to clause 10, 11, 12, 13, 14 or 15, further including determining a calculated comfort level associated with the user based on receiving a plurality of preferences associated with the user.

Clause 17. A system may include: a non-transient computer memory, storing software instructions; at least one processor of a first computing device associated with a user; wherein, when the at least one processor executes the software instructions, the first computing device is programmed to: obtain, by at least one processor of a first computing device associated with a user, via at least one graphical user interface (GUI) having at least one programmable GUI element, a permission from the user to monitor a plurality of activities executed within the computing device; continually monitor, by the at least one processor of the first computing device, in response to obtaining the permission from the user, the plurality of activities executed within the computing device for a predetermined period of time; identify, by the at least one processor of the first computing device, an indication of an incoming interaction session being initiated with the user within the predetermined period of time; automatically verify, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters; determine, by the at least one processor of the first computing device, a plurality of inquires associated with the research interaction session based on the at least one session interaction parameter, wherein the plurality of inquires require a plurality of demographic informational items associated with the user; identify, by the at least one processor of the first computing device, the plurality of demographic informational items associated with the user; and automatically update, by the at least one processor of the first computing device, the at least one GUI having the at least one programmable GUI element to display: i) the plurality of inquires associated with the research interaction session and ii) the plurality of demographic informational items associated with the user.

Clause 18. The system according to clause 17, where the software instructions further include the first computing device is programmed to automatically halt a continual monitoring the plurality of activities based on the plurality of inquires associated with the research interaction session meeting or exceeding a predetermined threshold of inquiries.

Clause 19. The system according to clause 17 or 18, where the software instructions further include the first computing device is programmed to: store a plurality of demographic information items associated with at least one second-type user in a pre-generated database of known entities; and automatically modify at least one second-type user-related record from the pre-generated database based on an at least one action by the at least one second-type user during at least one user-specific interaction session prior to the research interaction session.

Clause 20. The system according to clause 17, 18 or 19, where the software instructions further include the first computing device is programmed to automatically reject the incoming interaction session based on the plurality of inquires associated with the research interaction session meeting or exceeding a predetermined threshold of comfort associated with the user.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A computer-implemented method comprising:
obtaining, by at least one processor of a first computing device associated with a user, via at least one graphical user interface (GUI) having at least one programmable GUI element, a permission from the user to monitor a plurality of activities executed within the computing device;
continually monitoring, by the at least one processor of the first computing device, in response to obtaining the permission from the user, the plurality of activities executed within the computing device for a predetermined period of time;
identifying, by the at least one processor of the first computing device, an indication of an incoming interaction session being initiated with the user within the predetermined period of time;
automatically verifying, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters;
determining, by the at least one processor of the first computing device, a plurality of inquires associated with the research interaction session based on the at least one session interaction parameter, wherein the plurality of inquires require a plurality of demographic informational items associated with the user;
identifying, by the at least one processor of the first computing device, the plurality of demographic informational items associated with the user; and
automatically updating, by the at least one processor of the first computing device, the at least one GUI having the at least one programmable GUI element to display:
i) the plurality of inquires associated with the research interaction session and
ii) the plurality of demographic informational items associated with the user.

2. The computer-implemented method of claim 1, further comprising automatically halting a continual monitoring the plurality of activities based on the plurality of inquires associated with the research interaction session meeting or exceeding a predetermined threshold of inquiries.

3. The computer-implemented method of claim 1, wherein determining the plurality of inquires associated with the incoming interaction session comprises utilizing a crowd sourcing algorithm to survey a plurality of previous users on respective interaction sessions within a plurality of previous interaction sessions.

4. The computer-implemented method of claim 1, wherein the first computing device is a mobile device; and wherein the incoming interaction session is an incoming phone call.

5. The computer-implemented method of claim 1, wherein the at least one session interaction parameter is a session interaction protocol certificate associated with the research interaction session.

6. The computer-implemented method of claim 1, wherein automatically updating the at least one GUI having the at least one programmable GUI element comprises:
retrieving at least one answer to each inquiry of the plurality of inquiries within the plurality of demographic informational items, and
displaying the at least one answer to each inquiry of the plurality of inquiries on the at least one GUI having the at least one programmable GUI element.

7. The computer-implemented method of claim 1, further comprising determining a calculated comfort level associated with the user based on receiving a plurality of preferences associated with the user.

8. The computer-implemented method of claim 1, further comprising:
storing a plurality of demographic information items associated with at least one second-type user in a pre-generated database of known entities; and
automatically modifying at least one second-type user-related record from the pre-generated database of known entities based on an at least one action by the at least one second-type user during at least one user-specific interaction session prior to the research interaction session.

9. The computer-implemented method of claim 1, further comprising automatically rejecting the incoming interaction session based on the plurality of inquires associated with the research interaction session meeting or exceeding a predetermined threshold of comfort level associated with the user.

10. A computer-implemented method comprising:
obtaining, by at least one processor of a first computing device associated with a user, via at least one graphical user interface (GUI) having at least one programmable GUI element, a permission from the user to monitor a plurality of activities executed within the computing device;
continually monitoring, by the at least one processor of the first computing device, in response to obtaining the permission from the user, the plurality of activities executed within the computing device for a predetermined period of time;
identifying, by the at least one processor of the first computing device, an indication of an incoming interaction session being initiated with the user within the predetermined period of time;
automatically verifying, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters;
storing a plurality of demographic information items associated with at least one second-type user in a pre-generated database of known entities
determining, by the at least one processor of the first computing device, a plurality of inquires associated with the research interaction session based on the at least one session interaction parameter, wherein the plurality of inquires require a plurality of demographic informational items associated with the user;
identifying, by the at least one processor of the first computing device, the plurality of demographic informational items associated with the user;
automatically updating, by the at least one processor of the first computing device, the at least one GUI having the at least one programmable GUI element to display:
i) the plurality of inquires associated with the research interaction session and
ii) the plurality of demographic informational items associated with the user; and
automatically rejecting the incoming interaction session based on the plurality of inquires associated with the research interaction session meeting or exceeding a predetermined threshold of comfort associated with the user.

11. The computer-implemented method of claim 10, further comprising automatically halting a continual monitoring the plurality of activities based on the plurality of inquires associated with the research interaction session meeting or exceeding a predetermined threshold of inquiries.

12. The computer-implemented method of claim 10, wherein determining the plurality of inquires associated with the incoming interaction session comprises utilizing a crowd sourcing algorithm to survey a plurality of previous users on respective interaction sessions within a plurality of previous interaction sessions.

13. The computer-implemented method of claim 10, wherein the first computing device is a mobile device; and wherein the incoming interaction session is an incoming phone call.

14. The computer-implemented method of claim 10, wherein the at least one session interaction parameter is a session interaction protocol certificate associated with the research interaction session.

15. The computer-implemented method of claim 1, wherein automatically updating the at least one GUI having the at least one programmable GUI element comprises:
retrieving at least one answer to each inquiry of the plurality of inquiries within the plurality of demographic informational items, and
displaying the at least one answer to each inquiry of the plurality of inquiries on the at least one GUI having the at least one programmable GUI element.

16. The computer-implemented method of claim 10, further comprising determining a calculated comfort level associated with the user based on receiving a plurality of preferences associated with the user.

17. A system comprising:
a non-transient computer memory, storing software instructions;
at least one processor of a first computing device associated with a user;
wherein, when the at least one processor executes the software instructions,
the first computing device is programmed to:
obtain, by at least one processor of a first computing device associated with a user, via at least one graphical user interface (GUI) having at least one programmable GUI element, a permission from the user to monitor a plurality of activities executed within the computing device;
continually monitor, by the at least one processor of the first computing device, in response to obtaining the permission from the user, the plurality of activities executed within the computing device for a predetermined period of time;
identify, by the at least one processor of the first computing device, an indication of an incoming interaction session being initiated with the user within the predetermined period of time;
automatically verify, by the at least one processor of the first computing device, at least one session interaction parameter associated with the incoming interaction session to identify the incoming interaction session as a research interaction session when the at least one session interaction parameter of the incoming interaction session is associated with at least one of a particular entity, a particular individual, or a particular physical location based on a database of known session interaction parameters;
determine, by the at least one processor of the first computing device, a plurality of inquires associated with the research interaction session based on the at least one session interaction parameter, wherein the plurality of inquires require a plurality of demographic informational items associated with the user;
identify, by the at least one processor of the first computing device, the plurality of demographic informational items associated with the user; and
automatically update, by the at least one processor of the first computing device, the at least one GUI having the at least one programmable GUI element to display:
i) the plurality of inquires associated with the research interaction session and
ii) the plurality of demographic informational items associated with the user.

18. The system of claim 17, wherein the software instructions further comprise the first computing device is programmed to automatically halt a continual monitoring the plurality of activities based on the plurality of inquires associated with the research interaction session meeting or exceeding a predetermined threshold of inquiries.

19. The system of claim 17, wherein the software instructions further comprise the first computing device is programmed to:
store a plurality of demographic information items associated with at least one second-type user in a pre-generated database of known entities; and
automatically modify at least one second-type user-related record from the pre-generated database based on an at least one action by the at least one second-type user during at least one user-specific interaction session prior to the research interaction session.

20. The system of claim 17, wherein the software instructions further comprise the first computing device is programmed to automatically reject the incoming interaction session based on the plurality of inquires associated with the research interaction session meeting or exceeding a predetermined threshold of comfort level associated with the user.
